(19) United States
(12) Patent Application Publication
(10) Pub. No.: US 2012/0315390 A1
(43) Pub. Date: Dec. 13, 2012

(54) PRODUCTION OF HIGH PURITY SILICON-COATED GRANULES

(75) Inventor: Daniel Ohs, Moses Lake, WA (US)

(73) Assignee: REC Silicon Inc.

(21) Appl. No.: 13/492,748

(22) Filed: Jun. 8, 2012

Related U.S. Application Data
(60) Provisional application No. 61/495,744, filed on Jun. 10, 2011.

(51) Int. Cl. B01J 8/18; B05D 7/00

(52) U.S. Cl. 427/213; 422/146

(57) ABSTRACT

Apparatus and methods are described for transporting and cooling silicon-coated granules produced in a fluidized bed reactor. The described system allows consistent silicon-coated granule production with fewer impurities than traditional silicon granule coolers. Granules flow from the reactor into a cooling vessel and subsequently are transported to a post production treatment system below the cooler. The cooling vessel is constructed as a single standpipe, vertical or near vertical, with a pipe diameter that allows granules to flow freely while providing adequate residence time for cooling. The standpipe is cooled by flowing a cooling medium through a passageway that extends along an external surface of the standpipe. The passageway can be provided by a pipe jacket or conduit.

### CROSS REFERENCE TO RELATED APPLICATION

This claims the benefit of U.S. Provisional Application No. 61/495,744, filed Jun. 10, 2011, which is incorporated herein by reference.

### FIELD

The present disclosure relates to a system and method for transporting and cooling silicon-coated granules produced in a fluidized bed reactor.

### BACKGROUND

Pure or high grade polycrystalline silicon (polysilicon) is a critical raw material for both the semiconductor (SC) and photovoltaic (PV) industries. While there are alternatives for specific photovoltaic applications, polysilicon will remain the preferred raw material in the near and foreseeable future. Hence, improving the availability of and economics for producing polysilicon will increase the growth opportunities for both industries.

The majority of polysilicon currently is produced by the commonly called Siemens hot-wire method wherein silicon is deposited by the decomposition of a silicon-bearing gas, typically silane or trichlorosilane (TCS). The silicon-bearing gas, usually mixed with other inert or reaction gases, is pyrolytically decomposed and deposited onto a heated silicon filament.

Another method that has gained recent interest is the pyrolytic decomposition of silicon-bearing gas in a fluidized bed of silicon granules. The silicon-bearing gas, usually mixed with other inert or reaction gases, is pyrolytically decomposed and deposited onto the granules that have been heated by heaters surrounding the fluidized bed. This method is an attractive alternative to produce polysilicon for the photovoltaic and semiconductor industries due to significantly lower energy consumption and the possibility for continuous production. These benefits are the result of excellent mass and heat transfer, a substantially increased deposition surface and continuous production. Compared with the Siemens-type reactor, a fluidized bed reactor offers considerably higher production rates at a fraction of the energy consumption. The fluidized bed reactor also can operate continuously and be highly automated to significantly reduce labor costs.

The fluidized bed reactor produces silicon in a granular form. In traditional designs of the silicon fluidized bed reactor, the produced granules are emptied into a granule handling system below the fluidized bed reactor. The granules usually are cooled before they enter the handling system to minimize the risk of high temperature, diffusion-related contamination and the need for high temperature equipment and instrumentation. Compact units with high cooling surface area, such as tube and shell coolers as described in Chemical Engineer's Handbook, Perry and Chilton, 5^{th} Edition, “Section 11—Heat Transfer Equipment,” traditionally are used for the cooling devices in such applications. These types of devices are prone to contaminate the granular silicon product because they have complex geometric surfaces that are difficult to coat with a non-contaminating material. They are also subject to process upsets due to cooling medium leaks from inherent mechanical and thermal stress issues.

### SUMMARY

Described herein are apparatuses and methods for transporting and cooling silicon-coated granules produced in a fluidized bed reactor. The described systems allow consistent silicon-coated granule production with fewer impurities than traditional silicon granule coolers. Granules flow from the reactor into a cooling vessel and subsequently are transported to a post production treatment system below the cooler. The cooling vessel is constructed as a single standpipe, vertical or near vertical, with a pipe diameter that allows granules to flow freely while providing adequate residence time for cooling. The standpipe primarily is cooled externally either by a jacketed pipe or with a cooling medium path extending in proximity to the external surface. The post treatment can include, but is not limited to, degassing hydrogen and traces of silane so granules can be handled under nitrogen or ambient atmosphere.

These arrangements allow cooling with minimum risk of contamination from cooling medium leakage because leaks will be contained outside the standpipe. Leak reduction is enhanced with the cooling medium path extending around the standpipe's external surface. And the pipe shape, with only a peripheral contact surface, is inherently less prone to contamination than a system with tube bundles in a shell. The disclosed systems are more robust and provide safer production than conventional systems by preventing the cooling medium from contacting the silicon-coated granules and minimizing the risk for areas of reduced cooling medium flow. Such areas of reduced flow can lead to overheating and evaporation, and result in overpressure that will upset production.

The standpipe can be lined or coated with non-contaminating material to produce higher quality material than traditional coolers. Additionally, the smoother flow path eliminates holdup in coolers after shutdown and thus increases overall production yields. It also facilitates maintenance cleanup during turnaround of a reactor.

The cooled silicon-coated granules are delivered from the standpipe to a post-production treatment system below the reactor. The post-production treatment can include, but is not limited to, degassing hydrogen and traces of silane so granules can be handled under nitrogen or ambient atmosphere.

A further refinement of the standpipe cooler provides improved granule quality through dedusting, silicon coating and dehydrogenation. Very fine silicon powder particles entrained within the product can be an explosion hazard under atmospheric conditions. Silicon powder particles can be entrained by countercurrent flow of gas through the pipe. Such entrainment will be much more efficient in a single tubular pipe design than a traditional cooler where multiple and rigorous flow paths make entrainment difficult. To further reduce the powder adhered to the granule surface, traces of silane can be introduced with the countercurrent gas to cause slow silicon deposition onto the granules. This deposition will create a chemically bonded layer of newly deposited silicon and result in a smoother granule surface. Adjusting the temperature profile and granule holdup through the standpipe cooler can improve dehydrogenation by allowing time for chemisorbed hydrogen to diffuse from the granules.

Features and advantages will become apparent from the following detailed description, which proceeds with reference to the accompanying drawings.

### BRIEF DESCRIPTION OF THE DRAWINGS

In the drawings:

FIG. 1 is a schematic diagram of a first fluidized bed reactor and standpipe cooler system.

FIG. 2 is a schematic diagram of a standpipe cooler having a cooling jacket.

FIG. 3 is a schematic diagram of a standpipe cooler having an external helical cooling conduit.

FIG. 4 is a schematic diagram of a standpipe cooler having an internal cooling conduit.

FIG. 5 is a schematic diagram of a standpipe cooler having multiple injection points.

### DETAILED DESCRIPTION

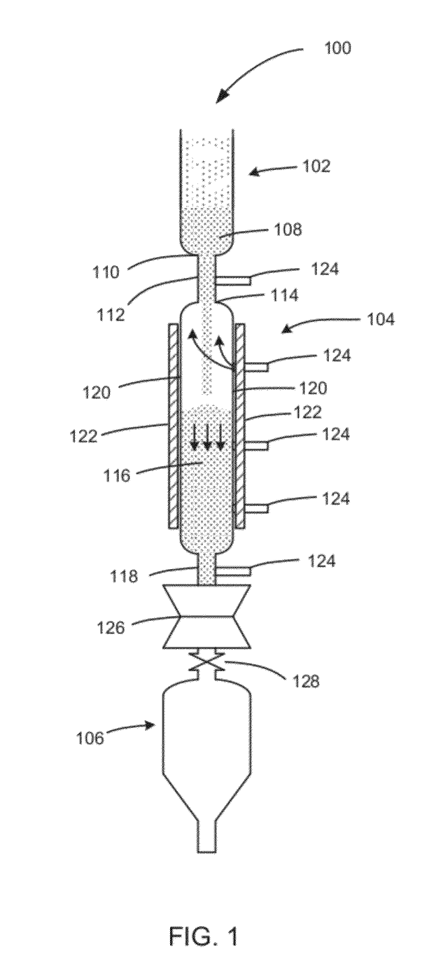

FIG. 1 shows a fluidized bed reactor and cooling system 100. The system comprises a fluidized bed reactor vessel 102 having a bottom-mounted outlet, a cooling vessel 104, and a post-production treatment system 106. The illustrated cooling vessel 104 is a substantially vertical standpipe granule cooler. Silicon-coated granules 108 are produced in the fluidized bed reactor 102 through the chemical vapor deposition of silicon onto starter granules in the reactor. A silicon-bearing gas enters the reactor 102 through an inlet (not shown) and decomposes pyrolytically in the reactor vessel, which is maintained at a sufficiently elevated temperature.

Starter granules may have any desired composition that is suitable for coating with silicon. Suitable compositions are those that do not melt or vaporize, and do not decompose or undergo a chemical reaction under the conditions present in the reactor chamber. Examples of suitable starter granule compositions include, but are not limited to, silicon, silica, graphite, and quartz. Starter granules may have any desired morphology. For example, the starter granules may be spheres, elongated particles (e.g., rods, fibers), plates, prisms, or any other desired shape. Starter granules also may have an irregular morphology. Typically starter granules have a diameter in the largest dimension of 0.1-0.8 mm, such as 0.2-0.7 mm or 0.2-0.4 mm.

Examples of silicon-bearing gases include, but are not limited to, silane and trichlorosilane. For simplicity, the use of silane is discussed in the examples herein, but it should be understood that similar operation would be possible with other silicon-bearing gasses of the type used for the production of polysilicon.

After growth to a sufficient size, silicon-coated granules 108 flow through an outlet nozzle 110 positioned at the bottom of the fluidized bed reactor 102 and then into a withdrawal pipe 112, which provides a passageway between the reactor and the cooling vessel 104. The granules 108 fall by gravity from the withdrawal pipe 112 through a standpipe inlet nozzle 114 into the standpipe main vessel 104 where the granules 108 form a moving packed bed 116. The packed granule bed 116 moves slowly down through the pipe 104 and out through the standpipe outlet 118.

As the packed granule bed 116 moves down through the standpipe vessel 104, the granules 108 are gradually cooled. Initial granule temperatures may be more than 1000° C. The main cooling is achieved by transferring heat to the cooled walls 120 of the pipe 104. The standpipe 104 may be surrounded by a cooling device 122.

Additional gas can be injected through separate injector nozzles 124 into the withdrawal pipe 112, into the standpipe 104, or into the standpipe outlet 118. This gas is referred to as withdrawal gas and can be any inert gas, appropriate silicon-bearing gas, or mixture thereof. A gas that is already present in the fluidized bed reactor 102 is preferred.

The withdrawal gas has multiple purposes. Additional cooling can be achieved by the injection of cold withdrawal gas into the standpipe 104. In some embodiments, the cold withdrawal gas flows co-currently with the granular flow. In other embodiments, the withdrawal gas typically flows countercurrently to the granular flow and creates a gas backflow into the reactor 102, minimizing the risk of reactor gas diffusing into the withdrawal pipe 112 and standpipe 104 where it could cause wall deposition and granule agglomeration. The withdrawal gas also entrains powder and small particles, thereby separating powder and small particles from the product granules 108 and moving the powder and small particles back up into the reactor 102, which minimizes escape of free-flowing powder and small particles with the product granules 108.

To further reduce the presence of powder adhered to the surfaces of product granules, traces of silicon-bearing gas can be introduced with the withdrawal gas and contacted with the granules 108 within the standpipe 104 at a temperature sufficient to cause slow silicon deposition onto the granules. This deposition creates a chemically bonded layer of newly deposited silicon and result in a smoother surface. The deposition reduces product dustiness by binding powder to the granules and also adds to the production yield. The concentration of silicon-bearing gas in the withdrawal gas and the gas flow rate can be balanced to minimize powder production and the potential for entrained silane in gases leaving with the product granules.

A high enough withdrawal gas flow can entrain practically all granules 108, thus limiting the flow of granules from the reactor 102 into the standpipe 104. Further, the gas cools the granules leaving the reactor 102 while also becoming preheated. This preheated withdrawal gas enters the reactor 102 carrying heat that can be used in the reactor 102, lowering the heating duty required of the bed heaters.

The cooling rate of granules 108 within the standpipe cooler 104 is a function of temperature differential, heat transfer efficiency, cooling area and cooling time. The granular flow rate is typically dictated by the fluidized bed reactor production rate to avoid accumulation. The temperature gradient is modified by the cooling medium temperature and possible multistage design of the cooling device 122 to maintain maximum cooling. Heat transfer efficiency is generally a function of granule size and reactor wall cleanliness. There is little variation in heat transfer efficiency during operation.

The size of the cooling area is a function of the packed bed level because most cooling occurs in the packed bed 116. The cooling time is a function of granular hold-up time in the standpipe 104. Granular hold-up time depends upon granular flow rates in and out of the standpipe 104. Granular in-flow is partially controlled by modifying the withdrawal gas flow, but typically varies with conditions of the fluidized bed reactor 102. Thus the primary control is the granule flow control device 126. Under steady state operation, the packed bed 116 level will be constant since flow in and flow out are equal. If granules 108 are removed from the standpipe 104 at a faster rate than granules 108 are entering the standpipe 104 from the fluidized bed reactor 102, the level of the packed bed 116 will decrease. Conversely, if granules 108 are removed from the standpipe 104 more slowly than granules 108 enter from the fluidized bed reactor 102, the level of the packed bed 116 will increase. A lower level results in a smaller cooling area and less cooling time for a given granular flow rate.

Adjusting the temperature profile and granule holdup time through the standpipe cooler 104 can improve dehydrogenation of the silicon-coated granules 108 by allowing time for chemisorbed hydrogen to diffuse from the granules 108. Within these controls, the operation of the standpipe cooler 104 can be continuous or batch as desired.

Cooled granular product exits through the bottom standpipe nozzle 118 and passes through a granule flow control device 126 into the post-production treatment system 106. The granule flow control device 126 functions as a valve that controls the granular flow rate out of the standpipe 104 and can completely stop the granule flow if required. The valve can be any valve capable of operating with granule flow. Typical valves include ball valves, slide gate valves and pinch valves, among others. The granule flow control device 126 typically is not gas-tight, so gas isolation valves 128 are used to isolate the standpipe cooler 104 and fluidized bed reactor 102 from the post production treatment system 106.

The primary purpose of the post-production treatment system 106 is to further eliminate free hydrogen gas and powder from the product. More advanced treatments, such as vacuum dehydrogenation, high temperature or extended hold time purging, and non-hydrogen gas purges, also may be applied if desired.

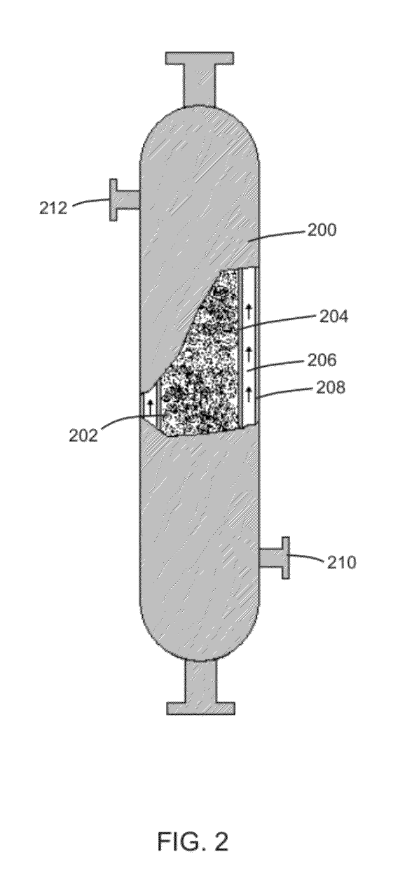

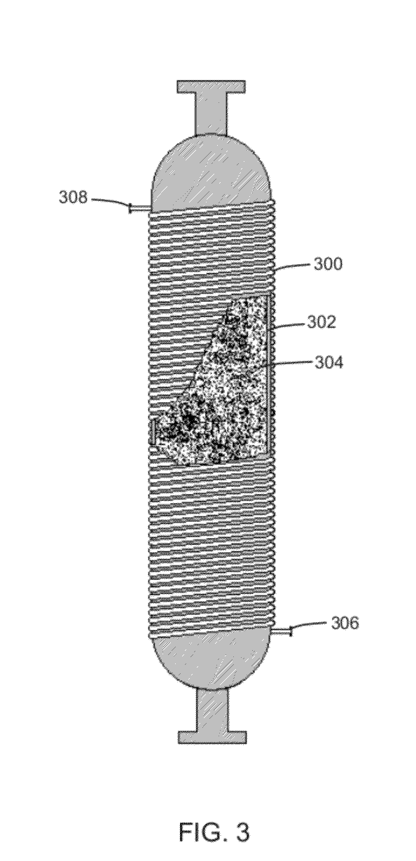

The granules in the packed bed are primarily cooled by the cold walls of the standpipe. FIGS. 2 and 3 illustrate two types of wall-cooling. One skilled in the art will understand that other wall cooling arrangements are possible.

In FIG. 2, a cooling jacket 200 surrounds the length of the standpipe 202. The illustrated cooling jacket 200 is adjacent and concentric to the outer wall 204 of the standpipe 202. Cooling medium 206 flows through a space between the outer wall 208 of the jacket 200 and the outer wall 204 of the standpipe 202, thus cooling the outer wall 204 of the standpipe 202. The cooling medium 204 is any free flowing medium, such as, but not limited to, cooling water, process gases or heated oil. Cooling medium 204 flows into a bottom opening 210 and out of a top opening 212 of the jacket 200.

FIG. 3 shows an arrangement where the cooling medium flows through a helical conduit or pipe 300 wound around the external wall 302 of the standpipe vessel. Cooling medium enters at the bottom opening 304 of the conduit 300 and exits at the top opening 306 of the conduit 300. A conduit is preferred over the cooling jacket from a quality and safety standpoint because the conduit eliminates any risk of cooling medium contacting hot silicon-coated granules in case of a leak. Hence there is no risk of sudden gas production from boiling cooling medium in the process and also no risk of granules being contaminated by cooling medium. In the case of a cooling jacketed standpipe, this is a concern. Furthermore, the continuous flow in a conduit is preferred. In a jacketed standpipe, dead zones with no flow can lead to stagnant areas where cooling medium can overheat and start to boil.

Cooling can be accomplished with a single one-through loop heat exchanger, as shown in FIG. 3, wherein a cooling tube is a continuous winding around the stand pipe cooler. Or cooling can be accomplished in multiple stages along various sections of the standpipe to create and control a temperature profile. Different cooling mediums and heat exchange configurations can be used at the various stages to optimize heat recovery.

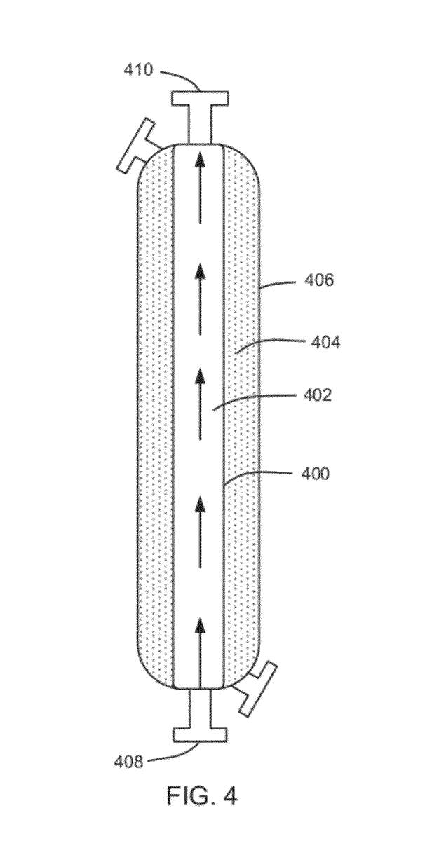

FIG. 4 illustrates an alternate embodiment of a standpipe cooler. An inner concentric wall 400 defines a substantially central channel 402 and an annular space 404 between the inner wall 400 and the outer wall 406 of the standpipe cooler. Cooling medium flows through the central channel. In some embodiments, cooling medium enters the central channel 402 through a bottom opening 408 and flows out of the central channel 402 through a top opening 410. A packed bed of granules moves downward in the annular space 404 between the inner wall 400 and the outer wall 406 and is cooled by the countercurrent flow of cooling medium. In other embodiments, the cooling medium may enter through the top opening 410 and flow out through the bottom opening 408, thus producing a co-current flow.

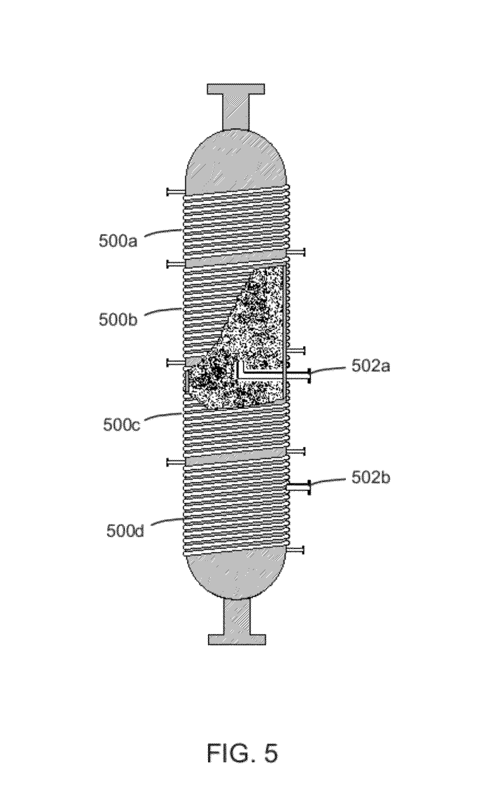

FIG. 5 illustrates one system wherein multiple cooling loops 500a-d are staged so that the cooling temperature can be varied at different elevations within the standpipe to optimize, for example, gas preheating. For further control, multiple injection points 502a, 502b are provided so that gases can be injected in stages.

The standpipe's inner surface may be coated with any material that reduces contamination of the granules. Examples of suitable coating materials include, but are not limited to, silicon carbide, pure silicon, quartz, and combinations thereof. Coatings can be added during standpipe manufacture. The geometry of a straight-through pipe allows coating materials to be applied by any suitable method, such as spray coating, chemical coating or slip-lining.

In an alternate arrangement, the standpipe may be constructed of a non-contaminating material such as ceramic, silicon carbide, or polysilicon tiles. Another approach is to prepare the standpipe prior to each operation by applying a chemical pretreatment that adds a non-contaminating, or less contaminating, layer to the inner standpipe wall.

### EXAMPLES

### Example 1

### Batch Production

In batch production, the packed bed level increases over time as granules flow into the standpipe cooler. At certain time intervals or at pre-determined packed bed levels, a batch of cooled granules is released into the post production treatment section. In one example, the standpipe is rapidly filled with granules and the standpipe fills completely. The granules remain in the standpipe and cool for a certain period of time. During this time period, the level of granules in the fluidized bed reactor increases since the standpipe is full and granules cannot flow into the standpipe. After the granules in the standpipe have cooled, they are released into the post-production treatment section. As the cooled granules flow out of the standpipe, hot granules from the fluidized bed reactor flow into the standpipe. The release of cooled granules is stopped as soon as the temperature of granules flowing out of the standpipe starts to increase. As the standpipe refills, the bed level in the fluidized bed reactor decreases.

In a typical example, granules flow into the standpipe at a temperature of about 700° C. The granule temperature drops over time while the granules cool in the standpipe. Once the temperature is acceptable for the downstream system, the cooled granules are released. Typical temperatures are shown in Table I.

TABLE I

Initial bed temperature = 700° C.
Temperature after 15 minutes = 400° C.
Temperature after 30 minutes = 200° C.
Temperature after 60 minutes = 40° C.
Outlet temperature at release = 40° C.
Outlet temperature after 3 min = 45° C.
Outlet temperature after 5 min = 60° C.
Solids valve closed after 5.5 min at 100° C.

### Example 2

### Continuous Production

In continuous operation, the solids outflow from the standpipe is adjusted such that the rates of granules entering and exiting the standpipe are equal and the level of the packed bed within the standpipe remains constant. During continuous operation, there will be a temperature profile, or gradient, through the packed bed. Typically the temperature is about 700° C. at the top of the packed bed where hot granules enter. The temperature decreases to about 40° C. at the bottom of the packed bed as granules flow out from the standpipe.

In view of the many possible embodiments to which the principles of the disclosed invention may be applied, it should be recognized that the illustrated embodiments are only preferred examples and should not be taken as limiting the scope of the invention. Rather, the scope of the invention is defined by the following claims.

1. A device for producing and cooling silicon-coated granules, the device comprising:
a fluidized bed reactor that defines a chamber to contain a plurality of granules, defines a fluidizing inlet for the injection of a gas to fluidize granules in the chamber, and defines an outlet for removing granules from the chamber;
a cooling vessel having an inlet in communication with the outlet of the fluidized bed reactor so that granules can pass from the chamber into the cooling vessel; and
a heat exchange device that defines at least one passageway adjacent the cooling vessel to conduct a stream of cooling medium alongside the cooling vessel to receive heat from granules within the vessel and thereby cool the granules.

2. The device of claim 1 wherein the cooling vessel is a substantially vertical standpipe.

3. The device of claim 2 wherein the passageway has a cooling medium inlet and has a cooling medium outlet that is located at an elevation above the cooling medium inlet.

4. The device of claim 1 wherein the heat exchange device comprises a cooling jacket surrounding the cooling vessel.

5. The device of claim 1 wherein the heat exchange device comprises at least one conduit extending around the cooling vessel.

6. The device of claim 5 comprising a plurality of conduits extending around the cooling vessel to provide separate paths for cooling media.

7. The device of claim 1 wherein:
the chamber is defined by an internal surface of the cooling vessel; and
the internal surface is coated with a non-contaminating material.

8. The device of claim 1 further comprising a withdrawal pipe that communicates with the outlet of the fluidized bed reactor and the inlet of the cooling vessel.

9. The device of claim 1 further comprising a granule flow control means operatively coupled to the outlet of the cooling vessel to control a flow of granules through the outlet.

10. The device of claim 1 wherein the granules comprise silicon granules, silica granules, graphite granules, quartz granules, or a combination thereof.

11. The device of claim 10 wherein the granules are silicon granules.

12. A process for treating silicon-coated granules formed in a fluidized bed reactor, the process comprising:
growing silicon-coated granules in a fluidized bed reactor at a first temperature;
transferring the silicon-coated granules into a cooling vessel;
transporting the silicon-coated granules through the cooling vessel in a packed bed; and
cooling the silicon-coated granules in the packed bed so that silicon-coated granules exit the cooling vessel at a second temperature, wherein the second temperature is lower than the first temperature.

13. The process of claim 12 further comprising cooling an outer wall of the cooling vessel by flowing a cooling medium through a cooling jacket, wherein the cooling jacket is located along the exterior of the cooling vessel.

14. The process of claim 12 further comprising cooling an outer wall of the cooling vessel by flowing a cooling medium through a conduit that extends around the exterior of the cooling vessel.

15. The process of claim 12 further comprising coating an inner surface of the cooling vessel with a non-contaminating material before transporting the silicon-coated granules through the cooling vessel.

16. The process of claim 12 further comprising regulating the flow of silicon-coated granules through the cooling vessel for batch operation such that the cooling vessel fills and empties at intervals.

17. The process of claim 12 further comprising regulating the flow of silicon-coated granules through the cooling vessel for continuous operation such that the packed bed is maintained at a generally constant level in the cooling vessel.

18. The process of claim 12 further comprising flowing a gas through the cooling vessel countercurrently to entrain powder back into the fluidized bed reactor.

19. The process of claim 18 wherein the countercurrently flowing gas is a silicon-bearing gas.

20. The process of claim 12 wherein the cooling is staged to maintain a temperature profile along a flow path through the cooling vessel.
